(19) United States
(12) Patent Application Publication
(10) Pub. No.: US 2014/0084823 A1
(43) Pub. Date: Mar. 27, 2014

(54) MOTOR CONTROLLING DEVICE AND MOTOR CONTROLLING METHOD

(71) Applicant: SAMSUNG ELECTRO-MECHANICS CO., LTD., Suwon (KR)

(72) Inventor: SOO WOONG LEE, Gyunggi-do (KR)

(73) Assignee: SAMSUNG ELECTRO-MECHANICS CO., LTD., Suwon (KR)

(21) Appl. No.: 13/843,230

(22) Filed: Mar. 15, 2013

(30) Foreign Application Priority Data
Sep. 24, 2012 (KR) 10-2012-0106049

(51) Int. Cl. H02P 31/00

(52) U.S. Cl. CPC H02P 31/00
USPC 318/400.09

(57) ABSTRACT

There are provided a motor controlling device and a motor controlling method. The motor controlling device includes: an open loop driving unit performing open loop controlling using a pulse width modulation (PWM) signal; a closed loop driving unit performing feedback controlling using a difference between a current speed of a motor and the PWM signal; and a driving controlling unit calculating a duty ratio of the PWM signal and comparing the calculated duty ratio with a preset reference duty to thereby control any one of the open loop driving unit and the closed loop driving unit to operate signal.

### CROSS-REFERENCE TO RELATED APPLICATIONS

This application claims the priority of Korean Patent Application No. 10-2012-0106049 filed on Sep. 24, 2012, in the Korean Intellectual Property Office, the disclosure of which is incorporated herein by reference.

### BACKGROUND OF THE INVENTION

1. Field of the Invention

The present invention relates to a motor controlling device and a motor controlling method capable of decreasing a difference in rotation of a motor, even at low speed, by using a combination of open loop controlling and closed loop controlling.

2. Description of the Related Art

Generally, a speed of a motor whose speed is able to be controlled, such as a brushless direct current (BLDC) motor, may be controlled through a duty value of a pulse width modulation (PWM) signal being adjusted. The duty value of the pulse width modulation signal may be determined according to a ratio between a turn-on time during which the signal has a high value in a single period thereof and a turn-off time during which the signal has a low value in a single period thereof, and RPM of the motor may be in proportion to the duty value of the pulse width modulation signal.

A scheme of controlling the speed of the motor may be mainly divided into open loop controlling and closed loop controlling. The open loop controlling scheme does not require a feedback circuit, such that it may be implemented in a simple structure; however, an error generated due to an external factor such as electrical noise, or the like, may not be compensated for.

In the case of the closed loop controlling scheme, since the speed of the motor is fed back, a constant speed may be maintained; however, when the speed of the motor is reduced by an external input signal, the motor stops due to overshooting. Further, in the case of the closed loop controlling scheme, since the speed control is not continuously performed, but is performed based on a predetermined unit, there is a limitation in that a difference in rotation is increased in a low speed region.

Therefore, in the case of using any one of the open loop controlling and the closed loop controlling, there is a limitation that it is difficult to overcome the above-mentioned problems.

The following Related Art Documents fail to disclose a technology of using a combination of the open loop controlling and the closed loop controlling.

Japanese Patent Laid-open Publication No. 1997-247976 discloses a technology of performing open loop controlling during initial driving and then performing closed loop controlling. However, Japanese Patent Laid-open Publication No. 1997-247976 has a limitation that conversion between the open loop controlling and the closed loop controlling may not be freely made.

Japanese Patent Laid-open Publication No. 2010-98922 discloses a technology of compensating for an output of a hall sensor according to temperature. However, Japanese Patent Laid-open Publication No. 2010-98922 does not disclose a technology of operating a combination of the open loop controlling and the closed loop controlling.

### RELATED ART DOCUMENT

(Patent Document 1) Japanese Patent Laid-open Publication No. 1997-247976
(Patent Document 2) Japanese Patent Laid-open Publication No. 2010-98922

### SUMMARY OF THE INVENTION

An aspect of the present invention provides a motor controlling device and a motor controlling method capable of decreasing a difference in rotation of a motor even at low speed by using a combination of open loop controlling and closed loop controlling.

According to an aspect of the present invention, there is provided a motor controlling device including: an open loop driving unit performing open loop controlling using a pulse width modulation (PWM) signal; a closed loop driving unit performing feedback controlling using a difference between a current speed of a motor and the PWM signal; and a driving controlling unit calculating a duty ratio of the PWM signal and comparing the calculated duty ratio with a preset reference duty to thereby control any one of the open loop driving unit and the closed loop driving unit to operate.

The driving controlling unit may include: a duty ratio calculator receiving the PWM signal and calculating the duty ratio of the PWM signal using a frequency of the received PWM signal; a reference duty determiner determining any one of a plurality of preset candidate reference duties as the reference duty; and a controller comparing the duty ratio with the reference duty to control the closed loop driving unit to operate when the duty ratio is greater than the reference duty.

The duty ratio calculator may receive the PWM signal and determine the duty ratio using the number of counter clocks corresponding to a high level for a predetermined period.

The reference duty determiner may include: a plurality of memories storing the plurality of candidate reference duties therein, respectively; and a plurality of switches connected to the plurality of memories, respectively, and the reference duty determiner may turn on any one of the plurality of switches and determine a duty stored in a memory connected to the turned-on switch as the reference duty.

The reference duty determiner may turn on any one of the plurality of switches according to a signal provided from the outside.

The controller may compare the duty ratio with the reference duty and provide a reference speed to the closed loop driving unit when the duty ratio is greater than the reference duty.

The closed loop driving unit may detect the current speed of the motor and control rotation of the motor so that a difference between the reference speed and the current speed is reduced.

The controller may control the open loop driving unit to operate when the duty ratio is lower than the reference duty.

The open loop driving unit may include: a triangular wave generator generating a triangular wave signal; an open loop synthesizer synthesizing an adjustment signal and the triangular wave signal to generate the PWM signal; and an open loop controller controlling driving of the motor according to the PWM signal generated in the open loop synthesizer.

According to another aspect of the present invention, there is provided a motor controlling method including: calculating a duty ratio of a PWM signal; and controlling a motor using any one of open loop controlling and closed loop controlling by comparing the calculated duty ratio with a preset reference duty.

The calculating of the duty ratio may include receiving the PWM signal and counting the number of counter clocks corresponding to a high level for a predetermined period to thereby determine the duty ratio.

The controlling of the motor may include: comparing the duty ratio with the reference duty; controlling the motor using the closed loop controlling when the duty ratio is greater than the reference duty; and controlling the motor using the open loop controlling when the duty ratio is lower than the reference duty.

The closed loop controlling may include: detecting a current speed of the motor; comparing the current speed with a reference speed; and controlling rotation of the motor so that a difference between the reference speed and the current speed is reduced.

The open loop controlling may include: synthesizing an adjustment signal and a triangular wave signal to generate the PWM signal; and controlling driving of the motor according to the PWM signal.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a graph showing a relationship between a pulse width modulation (PWM) duty and revolutions per minute (RPM) in motor controlling;

FIG. 2 is a graph showing a relationship between a triangular wave and a PWM speed control;

FIG. 3 is a configuration diagram illustrating a motor controlling device according to an embodiment of the present invention;

FIG. 4 is a detailed configuration diagram for describing an example of a driving controlling unit of FIG. 3;

FIG. 5 is a detailed circuit diagram for describing an example of the driving controlling unit of FIG. 4;

FIG. 6 is a detailed configuration diagram for describing an example of a closed loop driving unit of FIG. 3;

FIG. 7 is a detailed configuration diagram for describing an example of an open loop driving unit of FIG. 3; and

FIG. 8 is a flowchart for describing a motor controlling method according to an embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of components may be exaggerated for clarity, and the same reference numerals will be used throughout to designate the same or like components.

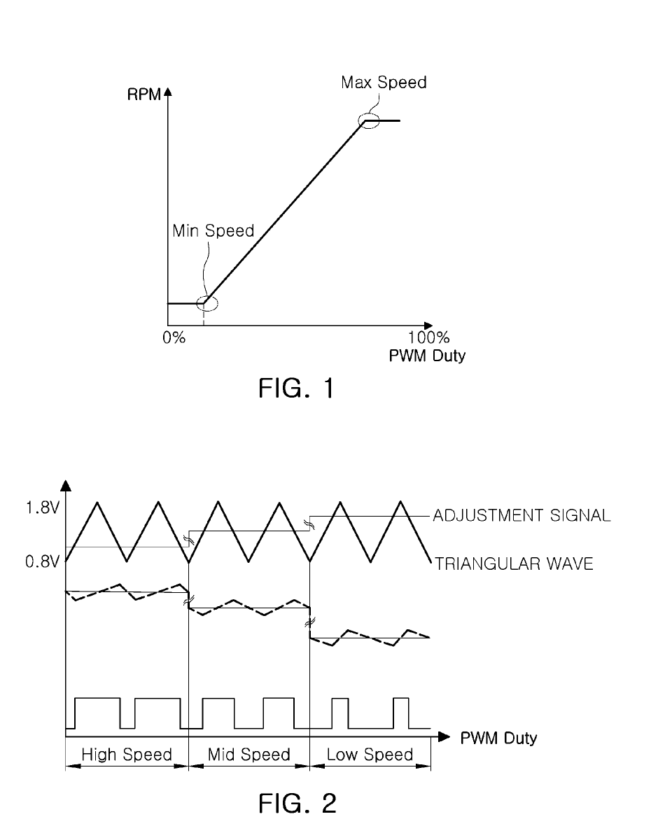

FIG. 1 is a graph showing a relationship between a pulse width modulation (PWM) duty and revolutions per minute (RPM) in motor controlling.

As shown in FIG. 1, a proportional relationship may exist between the PWM duty and revolutions per minute (RPM) of the motor. That is, as the PWM duty increases, the RPM may also increase linearly.

According to the embodiment of the present invention, a minimum speed and a maximum speed may be set to be specific speeds, respectively, and the PWM duty and the RPM may have a linear relationship between the minimum speed and the maximum speed thereof, as shown in FIG. 1.

FIG. 2 is a graph showing a relationship between a triangular wave and a PWM speed control.

As shown in FIG. 2, the duty of the PWM signal may be determined using a predetermined reference signal (for example, a triangular wave signal) and an adjustment signal. Therefore, when the adjustment signal has a low voltage, the PWM duty increases, such that the speed of the motor increases. On the other hand, when the adjustment signal has a high voltage, the PWM duty decreases, such that the speed of the motor decreases.

In open loop controlling, the driving speed of the motor may be controlled using the triangular wave signal and the adjustment signal. However, in the open loop controlling, when a change in an environment occurs due to voltage, noise, or the like, an error occurs. That is, the open loop controlling has unstable characteristics.

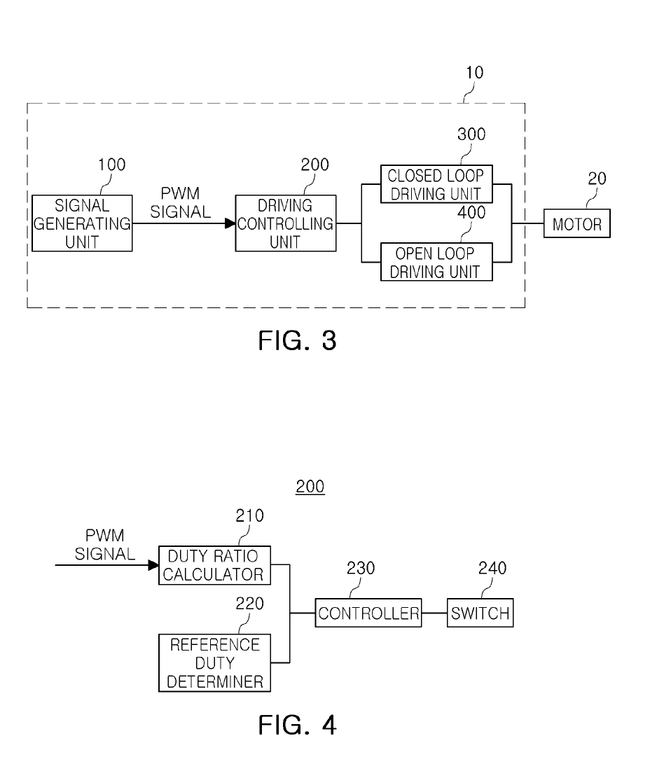

Hereinafter, a motor controlling device and a motor controlling method according to an embodiment of the present invention will be described with reference to FIGS. 3 through 8.

In a motor controlling device and a motor controlling method according to an embodiment of the present invention to be described below, a combination of open loop controlling and closed loop controlling may be used. For example, according to the embodiment of the present invention, the open loop controlling may be undertaken at a low speed to decrease a difference in speed, and the closed loop controlling may be undertaken at a high speed to compensate for an error generated due to an external factor.

FIG. 3 is a configuration diagram illustrating a motor controlling device according to an embodiment of the present invention.

A motor controlling device 10 may control driving of a motor 20 using any one of a closed loop driving unit 300 and an open loop driving unit 400.

More specifically, the motor controlling device 10 may include a driving controlling unit 200, the closed loop driving unit 300, and the open loop driving unit 400. In the embodiment of the present invention, the motor controlling device 10 may further include a signal generating unit 100.

The signal generating unit 100 may generate a pulse width modulation (PWM) signal.

According to the embodiment of the present invention, the signal generating unit 100 may be included in at least one of the driving controlling unit 200 and the open loop driving unit 400 or be configured as a separate component as shown in FIG. 3.

The driving controlling unit 200 may control any one of the open loop driving unit 400 and the closed loop driving unit 300 to operate using a reference duty.

In the embodiment of the present invention, the driving controlling unit 200 may calculate a duty ratio of the PWM signal and compare the calculated duty ratio with a preset reference duty to thereby control any one of the open loop driving unit 400 and the closed loop driving unit 300 to operate.

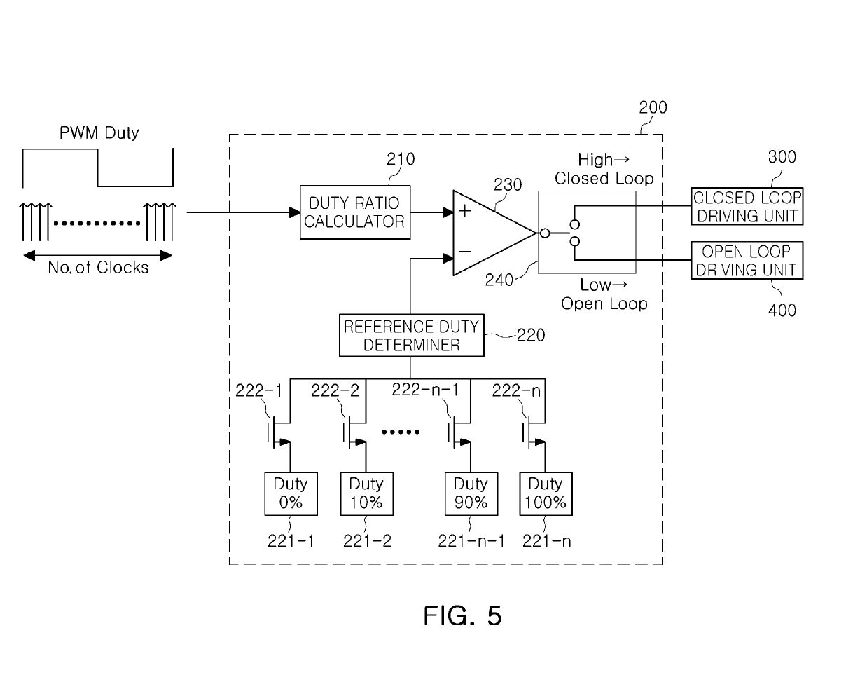

The driving controlling unit 200 will be described below in more detail with reference to FIGS. 4 and 5.

The closed loop driving unit 300 may perform feedback controlling using a difference between a current speed of the motor and the PWM signal, and the open loop driving unit 400 may perform open loop controlling using the PWM signal.

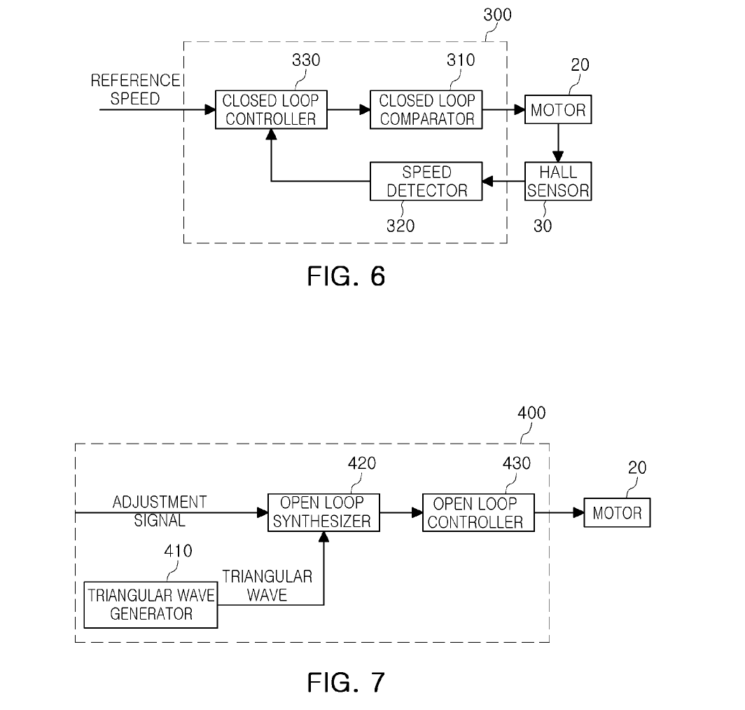

The closed loop driving unit 300 and the open loop driving unit 400 may be implemented in various forms. That is, detailed configurations of the closed loop driving unit 300 and the open loop driving unit 400 are not limited to specific embodiments. Therefore, it is obvious that embodiments of the closed loop driving unit 300 and the open loop driving unit 400 to be described below with reference to FIGS. 6 and 7 are merely exemplary, and are not limited to the configurations shown in FIGS. 6 and 7.

FIG. 4 is a detailed configuration diagram illustrating an example of a driving controlling unit of FIG. 3; FIG. 5 is a detailed circuit diagram for describing an example of the driving controlling unit of FIG. 4.

Hereinafter, various embodiments of the driving controlling unit 200 will be described with reference to FIGS. 4 and 5.

The driving controlling unit 200 may include a duty ratio calculator 210, a reference duty determiner 220, and a controller 230. In the embodiment of the present invention, the driving controlling unit 200 may further include a switch 240.

The duty ratio calculator 210 may calculate a duty ratio of the PWM signal. For example, the duty ratio calculator 210 may receive the PWM signal and calculate a duty ratio of the PWM signal using a frequency of the received PWM signal.

In the embodiment of the present invention, the duty ratio calculator 210 may receive the PWM signal and determine the duty ratio using the number of counter clocks corresponding to a high level within a predetermined period.

For example, the duty ratio calculator 210 may receive the PWM signal for a predetermined period. Here, the predetermined period may be counted by a counter. When it is assumed that the PWM signal has a frequency of 1 kHz and a clock of the counter has a frequency of 1 MHz, the counter performs counting one thousand times during a single period of the PWM signal. The duty ratio calculator 210 may only calculate outputs, which are high, among one thousand counter clocks to determine the PWM duty ratio. For example, when five hundred outputs are high, the duty ratio calculator 210 may calculate the duty ratio as 50%.

According to the embodiment of the present invention, the duty ratio calculator 210 may use a plurality of periods of the PWM signal. In the above-mentioned example, in the case in which one hundred periods of the PWM signal are used, one hundred thousand counting clocks may occur. The duty ratio calculator 210 may calculate outputs, which are high, among about one hundred thousand counting results to determine the PWM duty ratio. In this case, since the accumulated periods are used, the duty ratio may be more accurately calculated.

The reference duty determiner 220 may determine a reference duty. Here, the reference duty may be compared with the duty ratio calculated by the duty ratio calculator 210 to thereby be used to determine whether open loop controlling should be performed or closed loop controlling should be performed.

In the embodiment of the present invention, the reference duty determiner 220 may determine any one of a plurality of preset candidate reference duties as the reference duty.

The reference duty determiner 220 may select any one of the plurality of candidate reference duties and determine the selected candidate reference duty as the reference duty.

Referring to an example shown in FIG. 5, the reference duty determiner 220 may include a plurality of memories 221-1 to 221-n and a plurality of switches 222-1 to 222-n. The plurality of memories 221-1 to 221-n may store the plurality of candidate reference duties therein, respectively. The plurality of switches 222-1 to 222-n may be connected to the plurality of memories in a 1:1 scheme, respectively. The reference duty determiner 220 may turn on any one of the plurality of switches 222-1 to 222-n to determine a duty stored in the memory connected to the corresponding switch as the reference duty.

In the embodiment of the present invention, the reference duty determiner 220 may turn on any one of the plurality of switches according to a signal provided from the outside.

According to the embodiment of the present invention, since a speed at which the open loop controlling is performed may be varied, various controls for driving of the motor may be provided.

The controller 230 may compare the duty ratio with the reference duty to control any one of the closed loop driving unit 300 and the open loop driving unit 400 to operate. In the case in which it is determined that the reference duty is 25%, the controller 230 may perform open loop controlling when a current duty ratio is 25% or less and perform closed loop controlling when the current duty ratio exceeds 25%.

In the embodiment of the present invention, the controller 230 may perform the open loop controlling to decrease a difference at a predetermined speed or less. That is, the predetermined speed may be determined based on the reference duty, and the controller 230 may control the open loop driving unit 400 to operate when the duty ratio is lower than the reference duty, while the controller 230 may control the closed loop driving unit 300 to operate when the duty ratio is greater than the reference duty.

In the embodiment of the present invention, the controller 230 may provide a reference speed to the closed loop driving unit 300 when the duty ratio is greater than the reference duty. Here, the reference speed may be a preset value or a value set by a controlling command provided from the outside.

FIG. 6 is a detailed configuration diagram illustrating an example of a closed loop driving unit of FIG. 3.

The closed loop driving unit 300 may compare a reference speed with a current speed of the motor and change the current speed so as to coincide with the reference speed.

More specifically, a speed detector 320 may sense a change in a level of a hall signal provided from a hall sensor 30 to detect the current speed of the motor.

A closed loop comparator 330 may output a result obtained by comparing the current speed with the reference speed, and a closed loop controller 310 may increase or decrease the speed of the motor 20 based on the value provided from the closed loop comparator 330.

In the embodiment of the present invention, the closed loop comparator 330 may detect the current speed of the motor 20 and control rotation of the motor 20 so that a difference between the reference speed and the current speed is reduced.

In the closed loop controlling as described above, since the current speed of the motor 20 may be fed back, the speed may be relatively consistently controlled.

Here, the reference speed may correspond to a desired PWM duty ratio, and the speed may be controlled based on a predetermined unit determined by a digital register. For example, in the case in which it is assumed that the maximum RPM of the motor is 10000 and the unit is 1%, the RPM may be increased by at least 100 units. In the case of controlling the RPM of 5950, since 5900 or 6000 is output, a difference of 50 RPM occurs.

This difference, 50 RPM, may be less effective at a high speed, but it may be about 10% of the entire RPM at a low speed (for example, 500 RPM), which significantly affects the driving of the motor. Therefore, in the embodiment of the present invention, the open loop controlling rather than the closed loop controlling is performed at low speed, whereby the motor may be driven while allowing the difference in rotation even at low speed to be reduced.

Although the hall sensor 30 is used in order to detect the speed of the motor 20 as shown in FIG. 6, it is obvious that the closed loop driving unit 300 according to the embodiment of the present invention is not necessarily limited to the configuration shown in FIG. 6. That is, even in the case of measuring a speed using a back electromotive force (BEMF) signal, the closed loop controlling as described above may be performed.

FIG. 7 is a detailed configuration diagram illustrating an example of the open loop driving unit of FIG. 3.

The open loop driving unit 400 may include a triangular wave generator 410, an open loop synthesizer 420, and an open loop controller 430.

The triangular wave generator 410 may generate a triangular wave signal.

The open loop synthesizer 420 synthesizes an adjustment signal and the triangular wave signal to generate a PWM signal.

The open loop controller 430 may control the driving of the motor 20 according to the PWM signal generated in the open loop synthesizer 420.

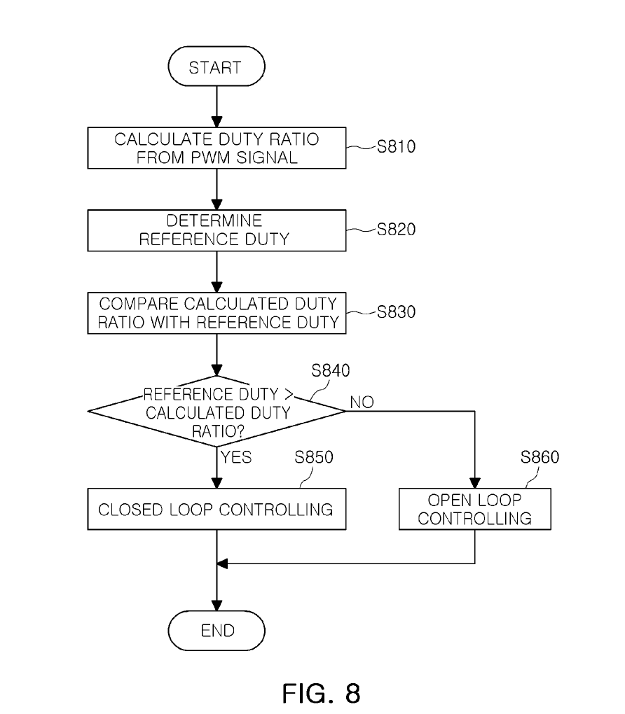

FIG. 8 is a flowchart for describing a motor controlling method according to an embodiment of the present invention.

Referring to FIG. 8, the motor controlling device 10 may calculate a duty ratio of a PWM signal (S810).

The motor controlling device 10 may determine a reference duty (S820), compare the calculated duty ratio with the reference duty (S830), and control the motor using any one of open loop driving control and closed loop driving control (S840 to S860).

In operation S810, the motor controlling device 10 may receive the PWM signal and count the number of counter clocks corresponding to a high level for a predetermined period to thereby determine the duty ratio.

The motor controlling device 10 may compare the duty ratio with the reference duty and control the motor using the closed loop driving control (S850) when the duty ratio is greater than the reference duty (S840, Yes). On the other hand, the motor controlling device 10 may control the motor using the open loop driving control (S860) when the duty ratio is lower than the reference duty (S840, No).

In operation S850 (closed loop controlling), the motor controlling device 10 may detect a current speed of the motor 10 and compare the current speed with a reference speed. The motor controlling device 10 may control rotation of the motor 10 so that a difference between the reference speed and the current speed is reduced.

In operation S860 (open loop controlling), the motor controlling device 10 may synthesize the adjustment signal and the triangular wave signal to generate the PWM signal and control the driving of the motor 10 according to the PWM signal.

As set forth above, according to embodiments of the present invention, a combination of open loop controlling and closed loop controlling is used, whereby a difference in rotation of the motor may be reduced even at low speed.

While the present invention has been shown and described in connection with the embodiments, it will be apparent to those skilled in the art that modifications and variations can be made without departing from the spirit and scope of the invention as defined by the appended claims.

What is claimed is:

1. A motor controlling device comprising:
an open loop driving unit performing open loop controlling using a pulse width modulation (PWM) signal;
a closed loop driving unit performing feedback controlling using a difference between a current speed of a motor and the PWM signal; and
a driving controlling unit calculating a duty ratio of the PWM signal and comparing the calculated duty ratio with a preset reference duty to thereby control any one of the open loop driving unit and the closed loop driving unit to operate.

2. The motor controlling unit of claim 1, wherein the driving controlling unit includes:
a duty ratio calculator receiving the PWM signal and calculating the duty ratio of the PWM signal using a frequency of the received PWM signal;
a reference duty determiner determining any one of a plurality of preset candidate reference duties as the reference duty; and
a controller comparing the duty ratio with the reference duty to control the closed loop driving unit to operate when the duty ratio is greater than the reference duty.

3. The motor controlling unit of claim 2, wherein the duty ratio calculator receives the PWM signal and determines the duty ratio using the number of counter clocks corresponding to a high level for a predetermined period.

4. The motor controlling unit of claim 2, wherein the reference duty determiner includes:
a plurality of memories storing the plurality of candidate reference duties therein, respectively; and
a plurality of switches connected to the plurality of memories, respectively, and
the reference duty determiner turns on any one of the plurality of switches and determines a duty stored in a memory connected to the turned-on switch as the reference duty.

5. The motor controlling unit of claim 4, wherein the reference duty determiner turns on any one of the plurality of switches according to a signal provided from the outside.

6. The motor controlling unit of claim 2, wherein the controller compares the duty ratio with the reference duty and provides a reference speed to the closed loop driving unit when the duty ratio is greater than the reference duty.

7. The motor controlling unit of claim 6, wherein the closed loop driving unit detects the current speed of the motor and controls rotation of the motor so that a difference between the reference speed and the current speed is reduced.

8. The motor controlling unit of claim 2, wherein the controller controls the open loop driving unit to operate when the duty ratio is lower than the reference duty.

9. The motor controlling unit of claim 8, wherein the open loop driving unit includes:
a triangular wave generator generating a triangular wave signal;
an open loop synthesizer synthesizing an adjustment signal and the triangular wave signal to generate the PWM signal; and
an open loop controller controlling driving of the motor according to the PWM signal generated in the open loop synthesizer.

10. A motor controlling method comprising:
calculating a duty ratio of a PWM signal; and
controlling a motor using any one of open loop controlling and closed loop controlling by comparing the calculated duty ratio with a preset reference duty.

11. The motor controlling method of claim 10, wherein the calculating of the duty ratio includes receiving the PWM signal and counting the number of counter clocks corresponding to a high level for a predetermined period to thereby determine the duty ratio.

12. The motor controlling method of claim 10, wherein the controlling of the motor includes:
comparing the duty ratio with the reference duty;
controlling the motor using the closed loop controlling when the duty ratio is greater than the reference duty; and
controlling the motor using the open loop controlling when the duty ratio is lower than the reference duty.

13. The motor controlling method of claim 12, wherein the closed loop controlling includes:
detecting a current speed of the motor;
comparing the current speed with a reference speed; and
controlling rotation of the motor so that a difference between the reference speed and the current speed is reduced.

14. The motor controlling method of claim 12, wherein the open loop controlling includes:
synthesizing an adjustment signal and a triangular wave signal to generate the PWM signal; and
controlling driving of the motor according to the PWM signal.
